(19) United States
(12) Patent Application Publication
(10) Pub. No.: US 2009/0271871 A1
(43) Pub. Date: Oct. 29, 2009

(54) INTELLIGENT UPLOADED CONTENT PLACEMENT

(75) Inventor: Peter Nied, East Fife, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/107,771

(22) Filed: Apr. 23, 2008

(51) Int. Cl. H04L 9/32; G06F 17/30; G06F 3/048

(52) U.S. Cl. 726/28; 707/104.1; 715/700; 707/E17.005

(57) ABSTRACT

Described herein is technology for, among other things, storing content (e.g., files) on a content storage system (e.g., online storage website). It involves various techniques for intelligently placing content in a hierarchy (e.g., folders) within the content storage system. Such intelligent placement of files facilitates easy use of the content storage system and speeds the upload process for users (e.g., via a single click). Therefore, the technology simplifies the uploading of files to an online file system.

### BACKGROUND

The widespread use and increasing development of the internet has allowed exchanges of information in ways previously not possible. The internet has made online storage readily available, reliable, and thereby facilitated information sharing.

Users may thus wish to upload content for web pages, photo albums, and social network pages. When a user wishes to upload a file, two conventional methods are often used to determine where the file is placed. When a file is to be public and no authentication is required, the file will be placed in a publicly visible area often with a non-human readable uniform resource locator (URL). Unfortunately if the URL is lost, access to the file will also be lost. Further if the user makes a mistake, he/she has no control over the file because there has been no authentication and thus can not easily remove or modify the file.

Users may also use systems allowing restricted access to files which require authentication to access the files. When a user is using an authenticated file storage system, he/she must choose the location where the file is to be placed. This approach has the drawback of requiring the user to take the additional steps of navigating to and selecting a location during a file upload process which can already takes numerous steps. If the users are no prompted for a location a problem exists of getting users to put files in the correct place.

Thus, what is needed is a way to allow users to easily upload files to an appropriate location without a laborious upload process.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, storing content (e.g., files) on a content storage system (e.g., online storage website). It involves various techniques for intelligently placing content in a hierarchy (e.g., folders) within the content storage system. Such intelligent placement of files facilitates easy use of the content storage system and speeds the upload process for users (e.g., via a single click). Therefore, the technology simplifies the uploading of files to an online file system.

In one implementation, a method of storing a piece of content may be used to intelligently store the piece of content. A graphical user interface (e.g., via a web browser) may be used facilitate selection of a piece of content. The content may then be received (e.g., via upload) by a content storage system (e.g., online storage or website). A storage location for the piece of content may then be determined based on the context (e.g., file extension, file properties, and user's current location within a hierarchy). The piece of content can then be stored in the determined location. Thus, users are relieved of the extra steps of further authentication or selecting a location for the piece of content.

Techniques described herein provide a way for the users to add content without taking extra steps to determine where content should be placed or stored. Thus, users are able easily upload content in a more efficient manner.

### BRIEF DESCRIPTION OF THE DRAWINGS

The accompanying drawings, which are incorporated in and form a part of this specification, illustrate embodiments and, together with the description, serve to explain their principles:

FIG. 1 is a block diagram of an exemplary computing system environment for implementing an embodiment.

FIG. 2 a block diagram of an exemplary graphical user interface in accordance with one embodiment.

FIG. 3 is a block diagram of an exemplary system for facilitating content storage, in accordance with an embodiment.

FIG. 4 is a flowchart of an exemplary process for storing a piece of content, in accordance with an embodiment.

FIG. 5 is a flowchart of an exemplary process for managing content, in accordance with an embodiment.

### DETAILED DESCRIPTION

Reference will now be made in detail to the preferred embodiments of the claimed subject matter, examples of which are illustrated in the accompanying drawings. While the invention will be described in conjunction with the preferred embodiments, it will be understood that they are not intended to limit the claimed subject matter to these embodiments. On the contrary, the claimed subject matter is intended to cover alternatives, modifications and equivalents, which may be included within the spirit and scope of the claimed subject matter as defined by the claims. Furthermore, in the detailed description of the present invention, numerous specific details are set forth in order to provide a thorough understanding of the claimed subject matter. However, it will be obvious to one of ordinary skill in the art that the claimed subject matter may be practiced without these specific details. In other instances, well known methods, procedures, components, and circuits have not been described in detail so as not to unnecessarily obscure aspects of the claimed subject matter.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the claimed subject matter.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

### Overview

Described herein is technology for, among other things, storing content (e.g., files) on a content storage system (e.g., online storage website). It involves various techniques for intelligently placing content in a hierarchy (e.g., folders) within the content storage system. Such intelligent placement of files facilitates easy use of the content storage system and speeds the upload process for users (e.g., via a single click). Therefore, the technology simplifies the uploading of files to an online file system.

In one implementation, a method of storing a piece of content may be used to intelligently store the piece of content. A graphical user interface (e.g., via a web browser) may be used facilitate selection of a piece of content. The content may then be received (e.g., via upload) by a content storage system (e.g., online storage or website). A storage location for the piece of content may then be determined based on the context (e.g., file extension, file properties, and user's current location within a hierarchy). The piece of content can then be stored in the determined location. Thus, users are relieved of the extra steps of further authentication or selecting a location for the piece of content.

Techniques described herein provide a way for the users to add content without taking extra steps to determine where content should be placed or stored. Thus, users are able easily upload content in a more efficient manner.

### Example Operating Environments

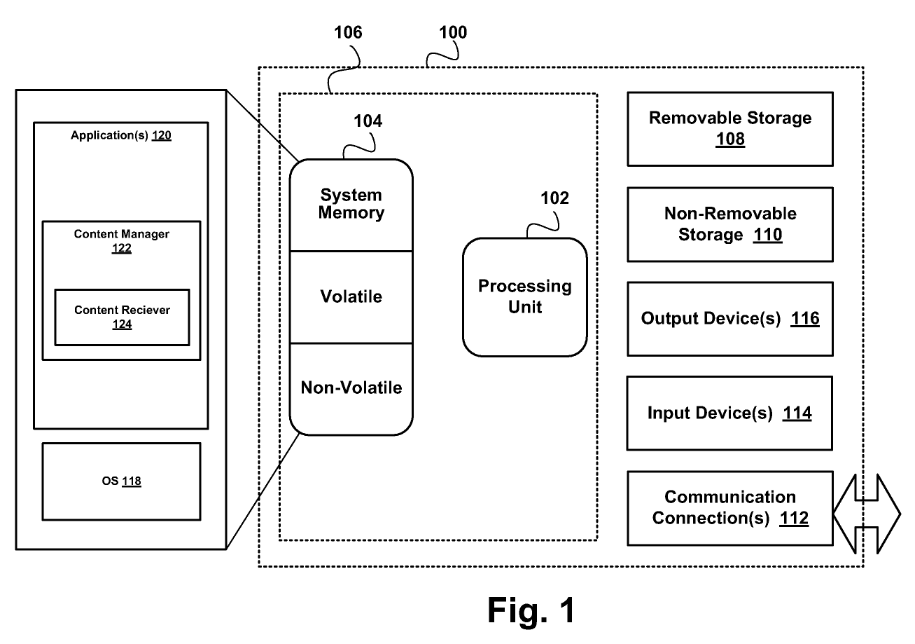

With reference to FIG. 1, an exemplary system for implementing embodiments includes a general purpose computing system environment, such as computing system environment 100. Computing system environment 100 may include, but is not limited to, servers, desktop computers, laptops, tablet PCs, mobile devices, and smartphones. In its most basic configuration, computing system environment 100 typically includes at least one processing unit 102 and memory 104. Depending on the exact configuration and type of computing system environment, memory 104 may be volatile (such as RAM), non-volatile (such as ROM, flash memory, etc.) or some combination of the two. This most basic configuration is illustrated in FIG. 1 by dashed line 106.

System memory 104 may include, among other things, Operating System 118 (OS), application(s) 120, and content manager 122. Content manager 122 may facilitate management of content that is public, limited access, and private (e.g., a website, a family photo album, and financial documents). Content manager 122 may further include content receiver 124 which handles receiving and storing of files. Content manager 122 may receive content (e.g., files) uploaded by users to locations under control of content manager 122 for access by the user and others. Content manger 122 may further store the uploaded content intelligently in a location and thereby make the upload process more efficient for a user. For example, a user who uploads a photo may have the photo automatically stored in a photos folder.

Additionally, computing system environment 100 may also have additional features/functionality. For example, computing system environment 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and nonremovable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 100. Any such computer storage media may be part of computing system environment 100.

Computing system environment 100 may also contain communications connection(s) 112 that allow it to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 112 may allow computing system environment 100 to communication over various networks types including, but not limited to, Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 112 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 100 may also have input device(s) 114 such as a keyboard, mouse, pen, voice input device, touch input device, remote control, etc. Output device(s) 116 such as a display, speakers, etc. may also be included. All these devices are well known in the art and need not be discussed at length here.

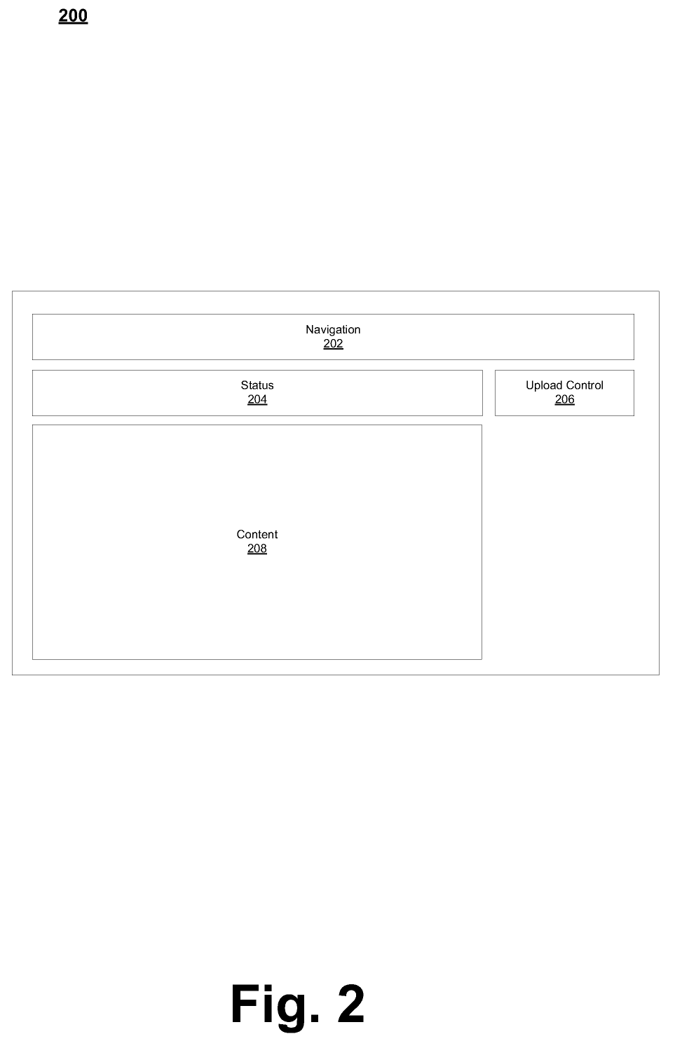

FIG. 2 is a block diagram 200 of an exemplary graphical user interface in accordance with one embodiment. Exemplary graphical user interface 200 may be presented after a user has been successfully authenticated and used to browse and initiate sending of content to a storage system via a web browser. For example, exemplary graphical user interface may be accessed or presented via web browser after logging in. It is appreciated that users may be authenticated in a variety of ways including, but not limited to, login and password, cookie, and encryption key. It is further appreciated that authentication may be performed by an authentication network which provides access to the various services associated with the authentication network (e.g., email, photo albums, instant messaging, etc.). Exemplary graphical user interface 200 includes navigation field 202, status field 204, upload control 206, and content area 208. It is appreciated that exemplary graphical user interface 200 may be used in a variety of applications including, but not limited to, web browsers or file browsers and provide access to other network services (e.g., social networks, email, etc.) and resources associated therewith.

Navigation field 202 facilitates navigating to various places within a storage resource or system. For example, Navigation field 202 may include a search box, links to other services associated with the storage resource, and links to areas within the storage system.

Upload control 206 facilitates a user in selecting content to upload. For example, when presented via web browser may allow a user to invoke via a single click a graphical user interface for the user to select the file he/she wants to add to the storage system. For example, a web browser may present a dialog for accessing files located on the user's local machine. In one embodiment, upload control 206 may be hidden, not shown, or inactive (e.g., non functional) if a user has not been authenticated.

After the piece of content (e.g., file) is selected, the content (e.g., via a post message from a webpage) may be sent to the storage system (e.g., system 100) and the selected piece of content is uploaded to the storage system. The piece of content may then be put through standard upload processes. In one embodiment, upload control 206 may reflect the current progress of the content upload (e.g., via a progress bar).

It is appreciated that a piece of content may be any of a variety of digital media including, but not limited to, photos, documents, videos, compressed files, encrypted files, music, configuration files, financial files, databases, web pages, programs, favorites or bookmarks, shortcuts, executables, installers, backup files, emails, and calendars. It is further appreciated that a piece of content may be spread across multiple files.

Status field 204 reflects the success or errors related to the content upload process. Any errors may cause the user to be placed in a standard uploaded experience with full information at his/her disposal to make a choice of how to continue.

The storage system may determine a location for the piece of content as described herein. Content may be put into one of several predetermined locations, photos, documents, movies, favorites (e.g., bookmarks), etc. In one embodiment, the predetermined location may be determined based on the file extension or file format of the content. After a file has been successfully uploaded and stored, the user may be brought (e.g., via a browser redirect) to the location (e.g., within a directory hierarchy) of the uploaded item.

Content area 208 displays the resources (e.g., webpages, files, folders, etc.) of the user's current location. For example, content area 208 may display thumbnails or the files within a user's photo album.

### Example System

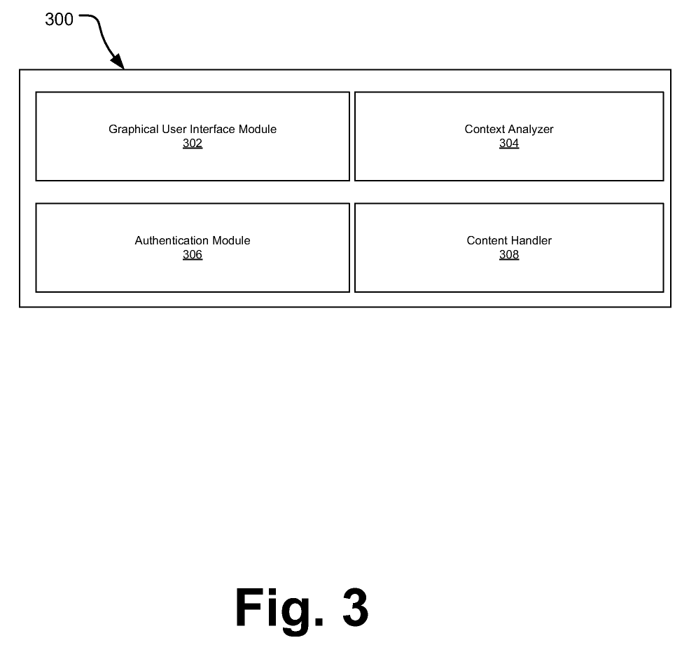

The following discussion sets forth details of the present technology systems for network communication management. FIG. 3 illustrates example components used by various embodiments of the present technology. System 300 includes components or modules that, in various embodiments, are carried out by a processor under the control of computer-readable and computer-executable instructions. The computer-readable and computer-executable instructions reside, for example, in data storage features such as computer usable memory 104, removable storage 108, and/or non-removable storage 110 of FIG. 1. The computer-readable and computer-executable instructions are used to control or operate in conjunction with, for example, processing unit 102 of FIG. 1. It should be appreciated that the aforementioned components of system 300 can be implemented in hardware or software or in a combination of both. Although specific components are disclosed in system 300 such components are examples. That is, embodiments are well suited to having various other components or variations of the components recited in system 300. It is appreciated that the components in system 300 may operate with other components than those presented, and that not all of the components of system 300 may be required to achieve the goals of system 300.

FIG. 3 shows a block diagram of an exemplary system 300 for facilitating content storage, in accordance with an embodiment. System 300 includes graphical user interface module 302, context analyzer 304, authentication module 306, and content handler 308.

Graphical user interface module 302 facilitates selection of a piece of content (e.g., a file such as photos, documents, videos, favorites or bookmarks, and that like). In one embodiment, graphical user interface module 302 generates a graphical user interface (e.g., graphical user interface 200) for display by a web browser (e.g., via HTML and JavaScript) which when clicked invokes a dialog box for a user to select locally stored content for upload to a content storage system. In one embodiment, a graphical user interface displayed via graphical user interface module 302 in response to a single click which invokes a content selection interface (e.g., a web browser file selection dialog box).

Context analyzer 304 determines a location for a piece of content to be stored. The location may be based the user's current location in a hierarchy (e.g., directory or folder hierarchy) within the storage system. For example, when a user is not in any directory structure (e.g., a root homepage or any homepage), on a friends public website, the determined location can be a public folder. If the user does not have a public folder, a public folder will be created with public permissions. The location may be a predefined location associated with a user account. For example, when a user creates an account the account may have predefined folders for photos, documents, videos, favorites, etc.

It should be noted that the term context as used herein includes, but it is not limited to, any information about a user, the content being uploaded, and any other information which may be used in determining where the piece of content should be placed. As described herein, context can include, but is not limited to, the file extension, file format, user's current location, and user's permission and access rights.

If the user is in a directory browsing page or any location rooted off of a page where there is a hierarchy (e.g., directory hierarchy), the location determined is the current location or point in the hierarchy. For example, if the user is within a “documents\tax returns” directory, the location will be determined to be the tax returns directory within the documents directory.

Similarly, if user is a contributor (e.g., one of multiple users who have add/delete rights, etc.) and is in a directory browse page or any location rooted off of a page where there is a hierarchy, the location determined is that point in the hierarchy. For example, if a user accesses a family photo album or website, the location will be determined to the current location within the family website.

The location may further be determined based on the file extension or format for the file. For example, if a photo file (e.g., JPEG or GIF) is uploaded, the location may be determined to be a photos folder. As another example, if a user selects a tax return, the format may be not recognized and thus may be put in the documents location or other nonpublic area. In one embodiment, a location may be determined solely on the file extension or format.

Authentication module 306 accesses authentication information. The authentication information can be used to examine the permissions a user has within a directory structure and be used in determining where a piece of content should be placed or if the user has the ability to upload. Thus, graphical interface module 302 may facilitate selection of a piece of content after authentication information has been accessed by authentication module 306. For example, an upload control (e.g., upload control 206) may be hidden or not displayed when a user does not have access to upload content. In one embodiment, authentication module 306 may access authentication information from a social network or authentication network. For example, a storage system may allow a user to see his/her friend's public or limited access content stores.

Content handler 308 receives and stores a piece of content based on the location determined by context analyzer 304. Content handler 308 further handles the communications for receiving uploaded content and the placement of the content in the determined location. Content handler 308 may receive content via the graphical user interface presented via graphical user interface module 302.

### Example Operations

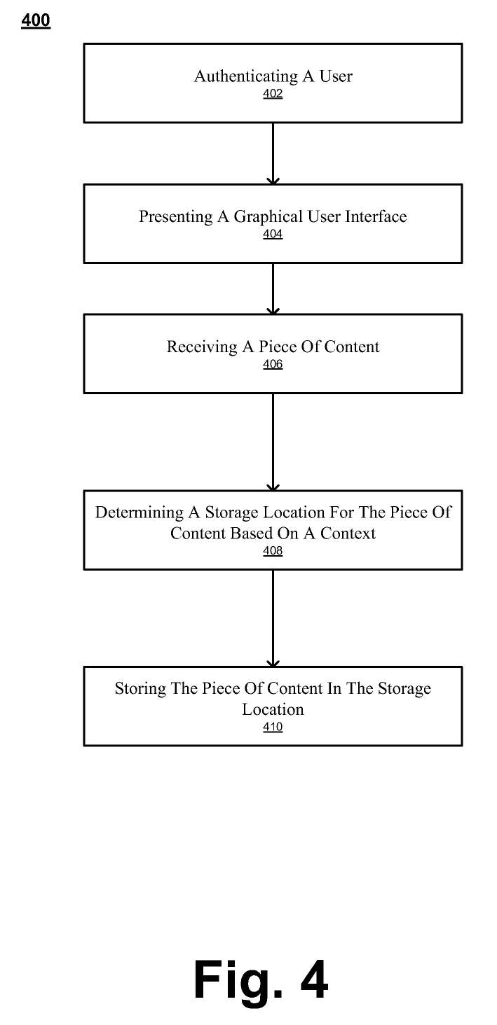

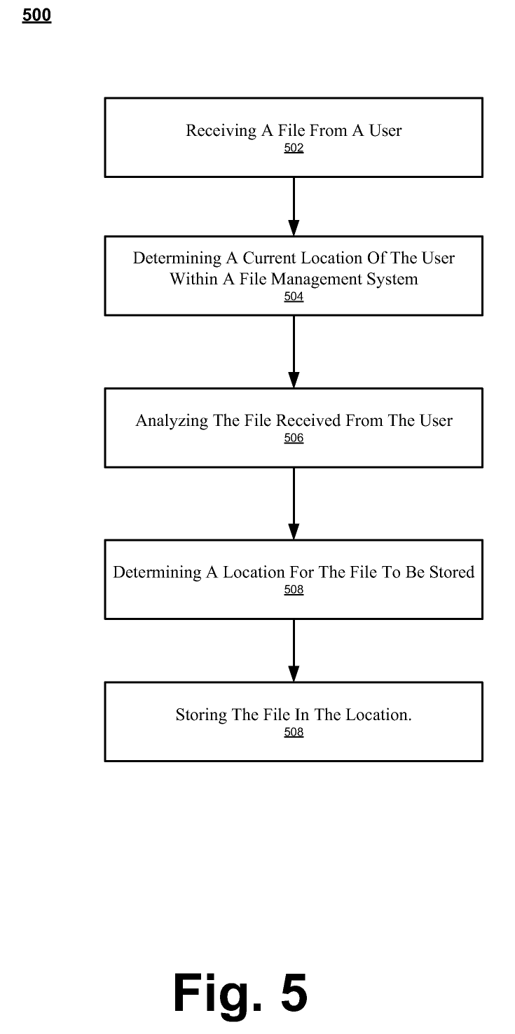

The following discussion sets forth in detail the operations of the present technology for content management. With reference to FIGS. 4 and 5, flowcharts 400 and 500 each illustrate example blocks used by various embodiments of the present technology. Flowcharts 400 and 500 include processes that, in various embodiments, are carried out by a processor under the control of computer-readable and computer-executable instructions. The computer-readable and computer-executable instructions reside, for example, in data storage features such as computer usable memory 104, removable storage 108, and/or non-removable storage 110 of FIG. 1. The computer-readable and computer-executable instructions are used to control or operate in conjunction with, for example, processing unit 102 of FIG. 1. Although specific blocks are disclosed in flowcharts 400 and 500 such blocks are examples. That is, embodiments are well suited to performing various other blocks or variations of the blocks recited in flowcharts 400 and 500. It is appreciated that the blocks in flowcharts 400 and 500 may be performed in an order different than presented, and that not all of the blocks in flowcharts 400 and 500 may be performed.

FIG. 4 is a flowchart 400 of an exemplary process for storing a piece of content, in accordance with an embodiment. The process of flowchart 400 may be carried out by a content management system (e.g., system 100) which may be part of a network with a variety of services (e.g., email, instant messaging, blogs, social networks, and the like).

At block 402, a user is authenticated for access to a content storage system. The content storage system (e.g., content manager 122) may be part of a content management system (e.g., website). Authentication information may be then be available for determining which resources (e.g., directories) a user has permission to access and can add content to. The authentication information may be available via an authentication network (e.g., a group of multiple services such as email, instant messaging, social networking, and content storage). The authentication network via the authentication information may be used to pre-determine the sign-in/out state of a user, verify the user's permissions level, and effectively making authentication implicit with visiting the content storage system.

At block 404, a graphical user interface is presented. The graphical user interface may facilitate content selection. As described herein, the graphical user interface may be rendered via a web browser. Further, the graphical user interface may presented or customized based on authentication information. For example, if a user has rights (e.g., permission or is signed in) the graphical user interface may facilitate access to the upload control (e.g., upload control 206) by putting the control on the page if access to uploading is allowed or hiding (e.g., not displaying) the upload control if access is denied.

At block 406, the piece of content is received. As described herein, the piece of content may be received via a web browser upload.

At block 408, a storage location for the piece of content is determined based on a context of the receiving of the piece of content. As described herein, the context can comprise properties of the piece of content including, but not limited to, the format of the piece of content (e.g., file format) and the file extension of the piece of content. The context may further include a location (e.g., location within a hierarchy) within a content management system. For example, a user's current location may be within the documents folder associated with their account. As described herein, the determined location may be a folder with public access, limited access, or user only access.

At block 410, the piece of content is stored in the determined storage location. As described herein, the user then may be brought or redirected to the storage location.

FIG. 5 is a flowchart 500 of an exemplary process for managing content, in accordance with an embodiment. The process of flowchart 500 may be carried out in conjunction with a graphical user interface (e.g., graphical user interface 200). The process of flowchart 500 may also be invoked or otherwise executed via a storage system (e.g., on a web server).

At block 502, a file is received from a user. As described herein, the file may be received via a web browser upload invoked via a graphical user interface (e.g., graphical user interface 200).

At block 504, a current location of the user is determined within a file management system. As described herein, the location may be a location (e.g., folder) within the directory hierarchy on content storage system (e.g., online storage system). For example, the user's current location can include a web page, a folder within the user's directory hierarchy, or a folder the user is a contributor to.

At block 506, the file received from the user is analyzed. As described herein, the file may be analyzed in a variety of ways including, but not limited to, the file extension and the file format.

At block 508, a location for the file to be stored is determined based on the determination of the current location and the analysis of the file. As described herein, the location determined may be a default location that was created upon creation of the user's account (e.g., photos, documents, etc.), a folder selected by the user to be a default upload location, or public folder when the location and file properties are not indicative of a location. At block 510, the file is stored in the determined location.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for storing a piece of content comprising:
presenting a graphical user interface, wherein said graphical user interface facilitates content selection;
receiving said piece of content;
determining a storage location for said piece of content based on a context of said receiving of said piece of content; and
storing said piece of content in said storage location.

2. The method as recited in claim 1 further comprising:
authenticating a user for access to a content storage system.

3. The method as recited in claim 1 wherein said context comprises proprieties of said piece of content.

4. The method as recited in claim 2 wherein said properties of said piece of content comprise a format of said piece of content.

5. The method as recited in claim 2 wherein said properties of said piece of content comprise a file extension of said piece of content.

6. The method as recited in claim 1 wherein said context comprises a location within a content management system.

7. The method as recited in claim 1 wherein said graphical user interface is presented via a web browser.

8. The method as recited in claim 1 wherein said graphical user interface is presented based on authentication information.

9. The method as recited in claim 8 wherein authentication information is available via an authentication network.

10. An apparatus for facilitating content storage comprising:
a graphical user interface module for facilitating selection of a piece of content;
a context analyzer for determining a location for a piece of content to be stored;
an authentication module for accessing authentication information; and
a content handler for receiving a piece of content and storing said piece of content based on said location determined by said context analyzer.

11. The apparatus as recited in claim 10 wherein said content handler further receives content via said graphical user interface.

12. The apparatus as recited in claim 10 wherein said location is a predefined location associated with a user account.

13. The apparatus as recited in claim 10 wherein said graphical user interface in response to a single click invokes a content selection interface.

14. The apparatus as recited in claim 10 wherein said graphical interface module facilitates selection of a piece of content after authentication information has been accessed by said authentication module.

15. The apparatus as recited in claim 10 wherein said authentication module accesses authentication information from a social network.

16. The apparatus as recited in claim 10 wherein said location allows said content to be publicly accessible.

17. The apparatus as recited in claim 10 wherein said location allows one or more users to add content to said location.

18. A computer-readable medium having computer-executable instructions for performing a method comprising:
receiving a file from a user;
determining a current location of said user within a file management system;
analyzing said file received from said user;
determining a location for said file to be stored based on said determining of said current location and said analyzing of said current location; and
storing said file in said location.

19. The computer-readable medium of claim 18 wherein said current location comprises a web page.

20. The computer-readable medium of claim 18 wherein said location for said file to be stored is a default location.
